(19) United States
(12) Patent Application Publication
(10) Pub. No.: US 2019/0028542 A1
(43) Pub. Date: Jan. 24, 2019

(54) METHOD AND DEVICE FOR TRANSMITTING DATA

(71) Applicant: SurCloud Corp., Union City, CA (US)

(72) Inventors: Donglin WANG, Beijing (CN); Youbing JIN, Beijing (CN)

(21) Appl. No.: 16/140,951

(22) Filed: Sep. 25, 2018

Related U.S. Application Data
(63) Continuation-in-part of application No. PCT/CN2017/077752, filed on Mar. 22, 2017.
Application No. PCT/CN2017/077752 is a continuation-in-part of application No. 16/054,536, filed on Aug. 3, 2018.
Application No. 16/054,536 is a continuation-in-part of application No. PCT/CN2017/071830, filed on Jan. 20, 2017.

(30) Foreign Application Priority Data
Feb. 3, 2016 (CN) 201610076422.6
Mar. 25, 2016 (CN) 201610181220.8

(51) Int. Cl. H04L 29/08; G06F 12/02; H04L 29/06; H04L 29/12

(52) U.S. Cl. CPC H04L 67/1097; G06F 12/0223; G06F 2212/154; H04L 61/2061; H04L 69/16

(57) ABSTRACT

The embodiments of the present invention provide a method and a device for transmitting data, which can improve the efficiency of data transmission greatly. The method for transmitting data is used in storage systems including shared storage pools, the method includes: receiving a data transmission request sent by an application program located at same physical server; storing the data to be transmitted in a shared storage pool of a storage system; and packaging the storage address of the data stored and sending the data package by a network protocol.

### CROSS-REFERENCE TO RELATED APPLICATIONS

This application is a Continuation-In-Part application of PCT application No. PCT/CN2017/077752, filed on Mar. 22, 2017 which claims priority to CN Patent Application No. 201610181220.8, filed on Mar. 25, 2016. This application is also a Continuation-In-Part application of U.S. patent application Ser. No. 16/054,536, filed on Aug. 3, 2018, which is a Continuation-In-Part application of PCT application No. PCT/CN2017/071830, filed on Jan. 20, 2017 which claims priority to CN Patent Application No. 201610076422.6, filed on Feb. 3, 2016. All of the aforementioned applications are hereby incorporated by reference in their entireties.

### TECHNICAL FIELD

Embodiments of the present invention relate to the technical field of computer communication systems, and more specifically, to a method and a device for transmitting data.

### BACKGROUND

Applications running on different servers share data with each other usually by a method of transferring all data from one server to another using a network protocol such as TCP/IP protocol, but the efficiency of data transmission in this way is low.

### SUMMARY

In view of this, the embodiments of the present invention aim at providing a method and a device for transmitting data, thereby improving efficiency of data transmission.

According to an embodiment of the present invention, a method for transmitting data is provided, that is used in storage systems including shared storage pools. The method for transmitting data includes: receiving a data transmission request sent by an application program located at a same physical server; storing the data to be transmitted in a shared storage pool of a storage system; packaging the storage address of the data stored and sending the data package by a network protocol.

According to an embodiment of the present invention, a device for transmitting data is provided, that is used in storage systems including shared storage pools. The device for transmitting data includes: receiving module, adapted to receive a data transmission request which is sent by an application program located at a same physical server; storage module, adapted to store the data to be transmitted in the shared storage pool of the storage system; a sending module, adapted to package the storage address of the data stored and send the data package by a network protocol.

According to the method and the device for transmitting data provided by the embodiments of the present invention, when a source server and a target server are located in a storage system that shares same shared storage pool, there is no need to transmit the data itself between the two server, but when providing a hardware scheme of the shared storage system, a map from a data file to corresponding data address is provided for the source server, and in the subsequent receiving terminal, a map from the data address to the corresponding data file is provided for the target server accordingly, in this way, the address of the data file can be transmitted between the source server and the target server without any modification of the application program on the source server and the application program on the target server, and there is no need to transmit all the data itself between the two servers, so that the efficiency of data transmission can be improved greatly.

### BRIEF DESCRIPTION OF DRAWINGS

FIG. 1 shows an architectural schematic diagram of a storage system provided by the prior art;

FIG. 2 shows an architectural schematic diagram of a storage system according to an embodiment of the present invention;

FIG. 3 shows an architectural schematic diagram of a storage system according to an embodiment of the present invention.

FIG. 4 shows a schematic diagram of a method for transmitting data according to an embodiment of the present invention;

FIG. 5 shows an architectural schematic diagram of a device for transmitting data according to an embodiment of the present invention.

### DETAILED DESCRIPTION

The present invention will be described more fully hereinafter with reference to the accompanying drawings, in which the embodiments of the present invention are shown. These embodiments can, however, be embodied in many different forms and should not be construed as being limited to the embodiments set forth herein. Rather, these embodiments are provided so that the present invention is thorough and complete, and fully convey scope of the present invention to those skilled in the art.

The various embodiments of the present invention are described in detail in the following examples by combining with the accompanying drawings.

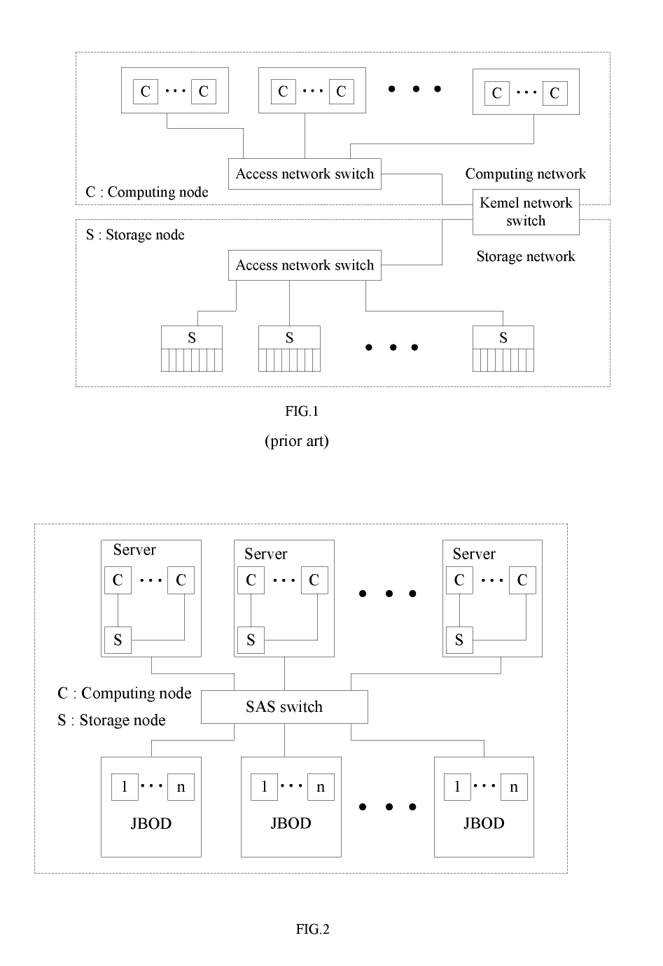

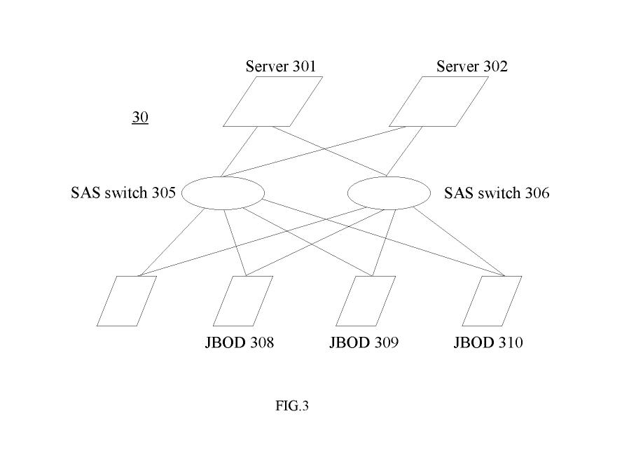

FIG. 2 shows an architectural schematic diagram of a storage system according to an embodiment of the present invention. As shown in FIG. 2, the storage system includes a storage network, storage nodes connected to the storage network, and storage devices also connected to the storage network. Wherein, the storage nodes are software modules that provide storage services, are not hardware servers that include storage mediums as often used in other documents. Each storage device includes at least one storage medium (hard drive, SSD, etc,). For example, a storage device commonly used by the inventor may include 45 storage mediums. Wherein, the storage network is configured to enable each storage node to access all the storage mediums without passing through other storage node.

In the storage system provided by the embodiments of the present invention, each storage node can access all the storage mediums without passing through other storage node, so that all the storage mediums are actually shared by all physical servers which the storage nodes are located, and therefore a global shared storage pool is achieved.

At the same time, compared with the prior art, in the embodiments of the present invention, the physical server where the storage node is located, is physically separated from the storage device, and the storage device is mainly used as a channel to connect the storage medium to the storage network.

In this way, there is no need to physically move data between different storage mediums when the rebalancing (adjust the relationship between data and storage node) is required, re-configure related storage nodes to balance data managed instead.

In an embodiment of the present invention, storage management software is a part of a storage node to access the storage mediums managed by the storage node. The storage location of the storage management software is not specifically limited. For example, it may be stored on the physical server of storage node (i.e. the physical server which a storage node is located) or stored on a JBOD. However, the storage management software is run on the physical server of storage node.

In another embodiment of the present invention, the physical server of a storage node further includes at least one computing node. By using the converged storage system in which the computing node and the storage node are located in same physical device provided by the embodiments of the present invention, the number of physical devices required can be reduced from the point of view of whole system, and thereby the cost is reduced. At the same time, the computing node can locally access any storage resource that they want to access. In addition, since the computing node and the storage node are converged in same physical server, data exchanging between the two can be as simple as memory sharing or API call, so the performance is particularly excellent.

In a storage system provided by an embodiment of the present invention, the I/O (input/output) data path between the computing node and the storage medium includes: (1) the path from the storage medium to the storage node via storage network; and (2) the path from the storage node to the computing node located in one same physical server with the storage node (via CPU bus or faster channel). TCP/IP protocol is not used within the full data path. However, in comparison, in the storage system provided by the prior art as shown in FIG. 1, the I/O data path between the computing node and the storage medium includes: (1) the path from the storage medium to the storage node; (2) the path from the storage node to the access network switch of the storage network; (3) the path from the access network switch of the storage network to the kernel network switch; (4) the path from the kernel network switch to the access network switch of the computing network; and (5) the path from the access network switch of the computing network to the computing node. The slow TCP/IP protocol is frequently used in this data path. It is apparent that the total data path of the storage system provided by the embodiments of the present invention is only close to item (1) of the conventional storage system. Therefore, the storage system provided by the embodiments of the present invention can greatly compress the data path, so that I/O channel performance of the storage system can be greatly improved, and the actual operation effect is very close to reading or writing a local drive. So, compared to the property of traditional networks like Ethernet, the property of the storage system can be improved greatly.

In an embodiment of the present invention, the storage node may be a virtual machine of a physical server, a container or a module running directly on a physical operating system of the server, and the computing node may also be a virtual machine of the local physical server, a container, or a module running directly on a physical operating system of the server. In an embodiment of the present invention, each storage node may correspond to one or more computing nodes.

Specifically, one physical server may be divided into multiple virtual machines, wherein one of the virtual machines may be used as the storage node, and the other virtual machines may be used as the computing nodes; or, in order to achieve a better performance, one module on the physical OS (operating system) may be used as the storage node.

In an embodiment of the present invention, the virtual machine may be built through one of following virtualization technologies: KVM, Zen, VMware and Hyper-V, and the container may be built through one of following container technologies: Docker, Rockett, Odin, Chef, LXC, Vagrant, Ansible, Zone, Jail and Hyper-V.

In an embodiment of the present invention, the storage nodes are only responsible for managing corresponding storage mediums respectively at the same time, and one storage medium cannot be simultaneously written by multiple storage nodes, so that data conflicts can be avoided. As a result each storage node can access the storage mediums managed by it without passing through other storage nodes, and integrity of the data stored in the storage system can be ensured.

In another embodiment of the present invention, the storage nodes divide storage pool based on storage block instead of storage medium. One storage block cannot be simultaneously written by multiple storage nodes, but multiple storage blocks within same storage medium can be simultaneously written by multiple storage nodes.

In an embodiment of the present invention, all the storage mediums in the system may be divided according to a storage logic hierarchy, specifically, the storage pool of the entire system may be divided according to a logical storage hierarchy which includes storage areas, storage groups and storage blocks, wherein, the storage block it is a complete storage medium or a part of a storage medium. In an embodiment of the present invention, the storage pool may be divided into at least two storage areas.

In an embodiment of the present invention, each storage area may be divided into at least one storage group. In a preferred embodiment, each storage area is divided into at least two storage groups.

In some embodiments of the present invention, the storage areas and the storage groups may be merged, so that one level may be omitted in the logical storage hierarchy.

In an embodiment of the present invention, each storage area (or storage group) may include at least one storage block, wherein the storage block may be one complete storage medium or a part of one storage medium. In order to build a redundant storage mode within the storage area, each storage area (or storage group) may include at least two storage blocks, when any one of the storage blocks fails, complete data stored can be calculated from the rest of the storage blocks in the storage area. The redundant storage mode may be a multi-copy mode, a redundant array of independent disks (RAID) mode, or an erasure code mode, or BCH (Bose-Chaudhuri-Hocquenghem) codes mode, or RC (Reed-Solomon) codes mode, or LDPC (low-density parity-check) codes mode, or a mode that adopts other error-correcting code. In an embodiment of the present invention, the redundant storage mode may be built through a ZFS (zettabyte file system). In an embodiment of the present invention, in order to deal with hardware failures of the storage devices/storage mediums, the storage blocks included in each storage area (or storage group) may not be located in one same storage medium, even not be located in one same storage device. In an embodiment of the present invention, any two storage blocks included in same storage area (or storage group) may not be located at a same storage medium, or even not located in one same storage device. In another embodiment of the present invention, in one storage area (or storage group), the number of the storage blocks located in same storage medium/storage device is preferably less than or equal to the fault tolerance level (the max number of failed storage blocks without losing data) of the redundant storage. For example, when the redundant storage applies RAIDS, the fault tolerance level is 1, so in one storage area (or storage group), the number of the storage blocks located in same storage medium/storage device is at most 1; for RAID6, the fault tolerance level of the redundant storage mode is 2, so in one storage area (or storage group), the number of the storage blocks located in same storage medium/storage device is at most 2.

In an embodiment of the present invention, each storage node can only read and write the storage areas managed by it. In another embodiment of the present invention, since multiple storage nodes do not conflict with each other when read one same storage block but easily conflict with each other when write one same storage block, each storage node can only write the storage areas managed by itself but can read the storage areas managed by itself and the storage areas managed by the other storage nodes. Thus it can be seen that writing operations are local, but reading operations are global.

In an embodiment of the present invention, when it is detected that a storage node fails, some or all of the other storage nodes may be configured to take over the storage areas previously managed by the failed storage node. For example, one of the other storage nodes may be configured to take over the storage areas previously managed by the failed storage node, or at least two of the other storage nodes may be configured to take over the storage areas previously managed by the failed storage node, wherein each storage node may be configured to take over a part of the storage areas previously managed by the failed storage node, for example the at least two of the other storage nodes may be configured to respectively take over different storage groups of the storage areas previously managed by the failed storage node.

In an embodiment of the present invention, the storage medium may include but is not limited to a hard disk, a flash storage, a SRAM (static random access memory), a DRAM (dynamic random access memory), a NVME (non-volatile memory express) storage, a 3DXPoint storage, or the like, and an access interface of the storage medium may include but is not limited to a SAS (serial attached SCSI) interface, a SATA (serial advanced technology attachment) interface, a PCI/e (peripheral component interface-express) interface, a DIMM (dual in-line memory module) interface, a NVMe (non-volatile memory express) interface, a SCSI (small computer systems interface), an Ethernet interface, an Infiniband interface, a Omipath interface, or an AHCI (advanced host controller interface).

In an embodiment of the present invention, the storage network may include at least one storage switching device, and the storage nodes access the storage mediums through data exchanging between the storage switching devices. Specifically, the storage nodes and the storage mediums are respectively connected to the storage switching device through a storage channel.

In an embodiment of the present invention, the storage switching device may be a SAS switch, an Ethernet switch, an Infiniband switch, an Omnipath switch or a PCI/e switch, and correspondingly the storage channel may be a SAS (Serial Attached SCSI) channel, an Ethernet channel, an Infiniband channel, an Omnipath channel or a PCI/e channel.

Taking the SAS channel as an example, compared with a conventional storage solution based on an IP protocol, the storage solution based on the SAS switch has advantages of high performance, large bandwidth, a single device including a large number of disks and so on. When a host bus adapter (HBA) or a SAS interface on a server motherboard is used in combination, storage mediums provided by the SAS system can be easily accessed simultaneously by multiple connected servers.

Specifically, the SAS switch and the storage device are connected through a SAS cable, and the storage device and the storage medium are also connected by the SAS interface, for example, the SAS channel in the storage device is connected to all storage mediums (a SAS switch chip may be set up inside the storage device). Because the bandwidth of the SAS network can reach 24 Gb or 48 Gb, which is dozens of times the bandwidth of the Gigabit Ethernet, and several times the bandwidth of the expensive 10-Gigabit Ethernet; at the same time, at the link layer, the SAS network has about an order of magnitude improvement over the IP network, and at the transmit layer, a TCP connection is established with a three handshake and closed with a four handshake, so the overhead is high, and Delayed Acknowledgement mechanism and Slow Start mechanism of the TCP protocol may cause a 100-millisecond-level delay, however the delay caused by the SAS protocol is only a few tenths of that of the TCP protocol, so there is a greater improvement in performance. In summary, the SAS network offers significant advantages in terms of bandwidth and delay over the Ethernet-based TCP/IP network. Those skilled in the art can understand that the performance of the PCI/e channel can also be adapted to meet the needs of the system.

In an embodiment of the present invention, the storage network may include at least two storage switching devices, each of the storage nodes can be connected to any storage device through any storage switching device, and further connect with the storage mediums. When a storage switching device or a storage channel connected to a storage switching device fails, the storage nodes can read and write the data on the storage devices through the other storage switching devices.

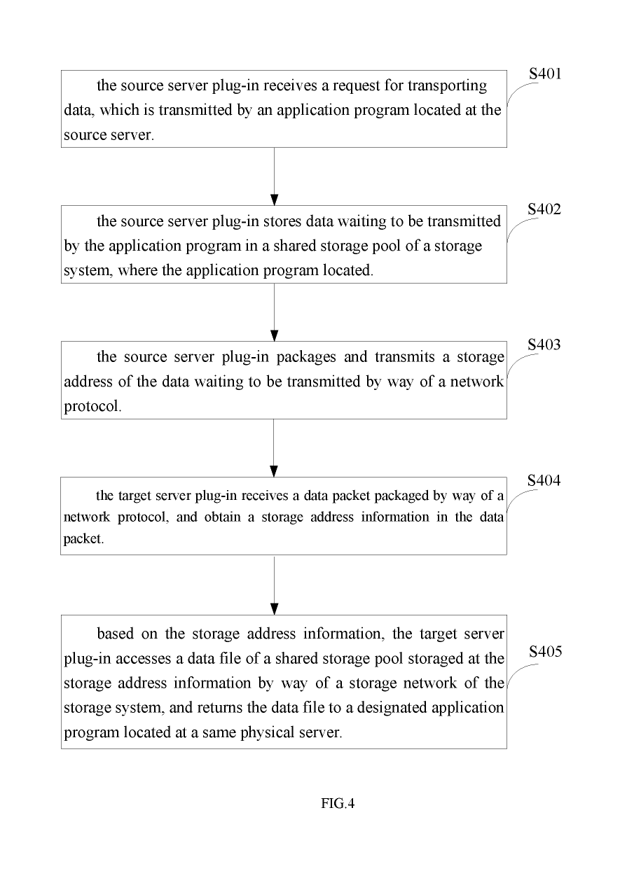

In FIG. 3, a specific storage system 30 provided by an embodiment of the present invention is illustrated. The storage devices in the storage system 30 are constructed as multiple JBODs (Just a Bunch of Disks) 307-310, these JBODs are respectively connected to two SAS switches 305 and 306 via SAS cables, and the two SAS switches constitute the switching core of the storage network included in the storage system. A front end includes at least two servers 301 and 302, and each of the servers is connected to the two SAS switches 305 and 306 through a HBA device (not shown) or a SAS interface on the motherboard. There is a basic network connection between the servers for monitoring and communication. Each of the servers has a storage node that manages some or all of the disks in all the JBODs. Specifically, the disks in the JBODs may be divided into different storage groups according to the storage areas, the storage groups, and the storage blocks described above. Each of the storage nodes manages one or more storage groups. When each of the storage groups applies the redundant storage mode, redundant storage metadata may be stored on the disks, so that the redundant storage mode may be directly identified from the disks by the other storage nodes.

In the exemplary storage system 30, a monitoring and management module may be installed in the storage node to be responsible for monitoring status of local storage and the other server. When a JBOD is overall abnormal or a certain disk on a JBOD is abnormal, data reliability is ensured by the redundant storage mode. When a server fails, the monitoring and management module in the storage node of another pre-set server will identify locally and take over the disks or storage blocks previously managed by the storage node of the failed server, according to the data on the disks. The storage services previously provided by the storage node of the failed server will also be continued on the storage node of the new server. At this point, a new global storage pool structure with high availability is achieved.

It can be seen that the exemplary storage system 30 provides a storage pool that supports multi-nodes control and global access. In terms of hardware, multiple servers are used to provide the services for external user, and the JBODs are used to accommodate the disks. Each of the JBODs is respectively connected to two SAS switches, and the two switches are respectively connected to a HBA card of the servers, thereby ensuring that all the disks on the JBODs can be accessed by all the servers. SAS redundant links also ensure high availability on the links.

On the local side of each server, according to the redundant storage technology, disks are selected from each JBOD to form the redundant storage mode, to avoid the data unable to be accessed due to the failure of one JBOD. When a server fails, the module that monitors the overall state may schedule another server to access the disks managed by the storage node of the failed server through the SAS channels, to quickly take over the disks previously managed by the failed server and achieve the global storage pool with high availability.

Although it is illustrated as an example in FIG. 3 that the JBODs may be used to accommodate the disks, it should be understood that the embodiment of the present invention shown in FIG. 3 also may apply other storage devices than the JBODs. In addition, the above description is based on the case that one (entire) storage medium is used as one storage block, but also applies to the case that a part of one storage medium is used as one storage block.

It should be understood that, in order not to make the embodiments of the present invention ambiguous, only some critical and unnecessary techniques and features are described, and some features that can be achieved by those skilled in the art may not described.

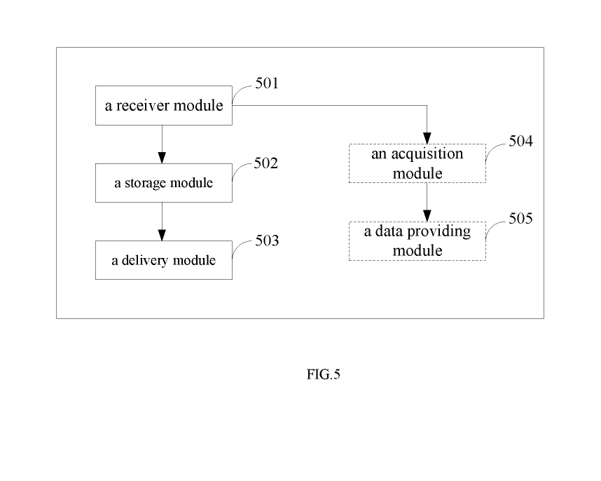

Based on the storage system with a shared storage pool shown in FIG. 2, when an application program in a physical server needs transmit data to an application program in another physical server, in an embodiment of the present invention, two plug-ins are installed on each of the two physical servers, in order to be conveniently described, the two physical servers are flagged as a source server and a target server, and the two plug-ins are flagged as a source server plug-in and a target server plug-in. The source server plug-in and the target server plug-in work together with each other, and a workflow of the source server plug-in and the target server plug-in working together with each other is shown in FIG. 4.

On the source server side, the source server plug-in performs the following steps:

Step 401: the source server plug-in receives a data transmission request, which is sent by an application program on the source server.

Step 402: the source server plug-in stores the data to be transmitted by the application program in a shared storage pool of the storage system. The data to be transmitted can be stored in one storage medium or multiple storage mediums of the shared storage pool.

Step 403: the source server plug-in packages the storage address of the data stored and sending the data package by a network protocol.

Utilizing the communication protocols provided by the prior art, such as TCP or IP or FTP or UDP or Ethernet and so on, the source server plug-in transmits the storage address of the data to the corresponding target server plug-in installed on the target server. It is understood by those skilled in the art that the communication methods provided by the prior art can be adopted for the communication between the source server and the target server, however, the communication methods between the source server and the target server cannot be used to limit the protection scope of the present invention.

The target server plug-in in the target server performs the following steps:

Step 404: the target server plug-in receives the data package by the network protocol and obtains the storage address from the data package. After the plug-in in the target server has received the data package by a communication protocol provided by the prior art, the plug-in unpackages the data package and obtains the information of the storage address from the data package, the methods provided by the prior art for unpackaging a data package can be adopted for the plug-in to unpackage the data package, the method for the plug-in to unpackage the data package cannot be used to limit the protection scope of the present invention.

Step 405: the target server plug-in obtains the data to be transmitted by the storage address from the shared storage pool of the storage system, and the target server plug-in sends the data to be transmitted to a target application program on the target server.

Wherein, when the application program in the source server sends a data transmission request, in addition to the data to be transmitted, the request also includes identify information (such as plus port number of IP-address) of the target server and the corresponding application program.

In an embodiment of the present invention, when the source server plug-in sends the data package, the data package includes identifications, indicating whether the data in the package is the address of the data file or the data file. After the target server plug-in has received a data package, once it is sure that the data package includes the address of the data file, the target server plug-in performs steps according to the above process and method in the embodiment of the present invention, or the data package includes the data file itself in which the target server plug-in performs steps provided by the prior art.

In this way, application programs in two servers in a storage system sharing a same shared storage pool can transmit data to each other in the shared storage system without any modification, so that the amount of data transmission in the shared storage system can be reduced greatly, and network resource of the shared storage system can be saved greatly. Of course, it is understood by those skilled in the art that, in practical application, application programs in each server can be a sender of the information or a receiver of the information, so the plug-in installed in each physical server has functions of a target server plug-in and a source server plug-in at the same time mentioned in above embodiments.

In an embodiment of the present invention, the storage system of each physical server in the shared storage system has stored software codes, when the software codes are performed, the steps performed by a target server plug-in and a source server plug-in described in the above embodiments can be performed by a virtual machine. A gateway needs to be passed through when the network communication is performed between an application program on the source server and an application program on the target server, in this case, the transformation can be realized in the gateway, and the gateway is transparent to the application programs.

In an embodiment of the present invention, the gateway corresponding to each physical server in the storage system has stored software codes, when the software codes are performed, the steps performed by a target server plug-in and a source server plug-in described in the above embodiments can be performed.

FIG. 5 shows an architectural schematic diagram of a device for transmitting data according to an embodiment of the present invention. As shown in FIG. 5, the device includes: a receiving module 501, which is adapted to receive a data transmission request which is sent by an application program located at same physical server; a storage module 502, which is adapted to store the data to be transmitted in the shared storage pool of a storage system; a sending module 503, which is adapted to package the storage address of the data stored and send the data package by a network protocol.

In an embodiment of the present invention, the receiving module 501 is further adapted to receive a data package by the network protocol. The device further includes: an obtaining module 504, which is adapted to obtain the storage address from the data package; a data providing module 505, which is adapted to obtain the data to be transmitted by the storage address from the shared storage pool of the storage system, and to send the data to be transmitted to a target application program located at the same physical server.

The above description is merely preferable embodiments of the present invention and is not intended to limit the scope of the present invention, any amendment or equivalent replacement, etc., within the spirit and the principle of the present invention, should be covered in the protection scope of the present invention.

What is claimed is:

1. A method for transmitting data, comprising:
receiving a data transmission request sent by an application program located at same physical server;
storing the data to be transmitted in a shared storage pool of a storage system;
packaging the storage address of the data stored and sending the data package by a network protocol.

2. The method of claim 1, the storage system comprising:
a storage network;
at least two storage nodes, connecting to the storage network;
at least one storage device, connecting to the storage network, wherein each storage device comprises at least one storage medium;
wherein the storage network is adapted to enable each of the at least two storage nodes to access all the storage mediums without passing through another storage node of the at least two storage nodes;
wherein all the storage mediums constitute the shared storage pool.

3. The method of claim 1, wherein the package sent by the network protocol further comprises identification information of a target application program.

4. The method of claim 1, further comprising:
receiving a data package by the network protocol, and obtaining the storage address from the data package;
obtaining the data to be transmitted by the storage address from the shared storage pool of the storage system, and sending the data to be transmitted to a target application program located at the same physical server.

5. The method of claim 1, wherein the network protocol comprises TCP or IP or UDP or FTP or Ethernet protocol.

6. The method of claim 2, wherein the storage network comprises a SAS network or a PCI/e network or an Infiniband network or an Omni-Path network, and the at least two storage nodes are connected with the at least one storage device through a SAS switch or a PCI/e switch or an Infiniband switch or an Omni-Path switch.

7. The method of claim 2, wherein a storage management software is run by the storage node to access the storage mediums managed by the storage node.

8. A device for transmitting data, used in a storage system including a shared storage pool, comprising:
receiving module, adapted to receive a data transmission request which is sent by an application program located at same physical server;
storage module, adapted to store the data to be transmitted in the shared storage pool of the storage system;
a sending module, adapted to package the storage address of the data stored and send the data package by a network protocol.

9. The device of claim 8, wherein the receiving module is further adapted to receive a data package by the network protocol;
the device further comprising:
obtaining module, adapted to obtain the storage address from the data package;
data providing module, adapted to obtain the data to be transmitted by the storage address from the shared storage pool of the storage system, and to send the data to be transmitted to a target application program located at the same physical server.

10. The device of claim 8, wherein the device is a module installed in the physical server or in a virtual machine of the physical server.

11. The device of claim 8, wherein the device is located at gateway of the physical server.
